(19) United States
(12) Patent Application Publication
(10) Pub. No.: US 2024/0422656 A1
(43) Pub. Date: Dec. 19, 2024

(54) Optimized management of virtual Wi-Fi access points

(71) Applicant: ORANGE, Issy-les-Moulineaux (FR)

(72) Inventors: Jean-Philippe Javaudin, CHATILLON CEDEX (FR); Jean-Michel Bonnamy, CHATILLON CEDEX (FR); Mael Le Dizes, CHATILLON CEDEX (FR)

(21) Appl. No.: 18/704,743

(22) PCT Filed: Oct. 24, 2022
(86) PCT No.: PCT/EP2022/079538

§ 371 Date: Apr. 25, 2024

(30) Foreign Application Priority Data
Oct. 28, 2021 (FR) FR2111469

(51) Int. Cl. H04W 48/16; H04W 48/10

(52) U.S. Cl. CPC H04W 48/16; H04W 48/10

(57) ABSTRACT

A method includes the following steps implemented by a physical Wi-Fi access point to which a first virtual Wi-Fi access point identified by a first BSSID identifier is assigned: receiving a message including the first BSSID identifier; repeated transmission of beacon messages including the first BSSID identifier; associating a Wi-Fi station with the physical Wi-Fi access point based on the first BSSID identifier; and stopping the repeated transmission of the beacon messages comprising the first BSSID identifier.

### 1. FIELD OF THE INVENTION

The invention lies in the field of Wi-Fi networks, and more particularly that of Wi-Fi networks using virtual access points, known as LVAPs (Light Virtual Access Points), managed by a central controller.

### 2. PRIOR ART

In conventional IEEE 802.11 networks, known as Wi-Fi networks, a station has to associate with a physical access point before being able to transmit and receive data frames. The association begins with a discovery phase, which is either active, where the station transmits probe requests, or passive, where it is the access points that regularly transmit beacons. In the former case, the access points respond with probe responses. On the basis either of the probe responses or of the beacons that it receives, the station then decides the access point with which it associates.

In conventional Wi-Fi networks, the association is defined by the MAC address of the station and the identifier of the access point, known as BSSID (Basic Service Set Identifier). If beacons are transmitted by the access points, in this case, the station sends only a unicast probe request to the access point with which the station wishes to associate. Without beacons, the station has to send a broadcast probe request, wait to receive all probe responses, analyze them and finally send a unicast probe request to the access point with which the station wishes to associate. It will be understood that the association is carried out far more quickly (from 10 ms to a few hundred ms) using beacons transmitted by access points than without beacons (up to 10 seconds).

The LVAP approach is an evolution of Wi-Fi networks that makes it possible, among other advantages, to cope with the large increase in the number of Wi-Fi stations and the mobility thereof. In this approach, virtual access points are created on physical access points and are controlled by a central entity, the controller. Such a virtual access point, called an LVAP access point, is assigned (or “mapped”, dedicated term) by the controller to a physical access point. An LVAP access point may also be moved by the controller without changing its BSSID identifier, thereby allowing a station associated with an LVAP access point to move from one physical access point to another, depending on its needs (in particular in terms of mobility), without having to restart a new association, and above all in a manner transparent for the station. The station therefore does not have to modify its compliance with the standards of conventional Wi-Fi networks to connect to a Wi-Fi network implementing LVAPs.

The identifier of an LVAP access point is not only unique to the LVAP access point, but also unique to the station that associates therewith. It is determined dynamically by the central entity and communicated to the station during the probe request/probe response exchange.

In this LVAP approach, associations are not carried out on the basis of beacons, but on the basis of probe request/probe response exchanges, and are slower than associations in conventional Wi-Fi networks, which are carried out on the basis of beacons.

One of the aims of the invention is to remedy these drawbacks of the prior art.

### 3. SUMMARY OF THE INVENTION

The invention aims to improve the situation by way of a method for the optimized management of virtual Wi-Fi access points, comprising the following steps implemented by a physical Wi-Fi access point to which a first virtual Wi-Fi access point identified by a first BSSID identifier is assigned:
Receiving a message comprising the first BSSID identifier;
Repeatedly transmitting beacon messages comprising the first BSSID identifier;
Associating a Wi-Fi station with the physical Wi-Fi access point on the basis of the first BSSID identifier;
Stopping the repeated transmission of the beacon messages comprising the first BSSID identifier.

By virtue of this method, the association of a station with an LVAP access point (in other words a virtual access point) is at least as fast as in the conventional case of a physical access point without an LVAP access point, because, for the LVAP access point or on behalf thereof, the physical access point regularly transmits a beacon signal in order to be discovered quickly by stations within signal range. In addition, since this beacon signal stops being transmitted after the LVAP access point has been associated with a station, the total number of beacon signals transmitted is less than that corresponding to the conventional case of a physical access point, where the beacon signals continue to be transmitted, with the same BSSID, after association with a station.

Indeed, the greater the number of beacon signals, the more congested the radio environment, this resulting in a drop in data rate and an increase in latency for equipments using this radio environment.

Indeed, since in theory a very large number of LVAP access points are able to be mapped to a single physical Wi-Fi access point (up to 64 or 128 at present, but with no theoretical limit), continuing the transmission would result in a large increase in the number of distinct beacons transmitted by all of the physical access points.

According to one aspect of the invention, the association is followed by:
Transmitting a message relating to the association, comprising the first BSSID identifier;
Receiving a message comprising a second BSSID identifier of a second virtual Wi-Fi access point assigned to the physical Wi-Fi access point;
Repeatedly transmitting beacon messages comprising the second BSSID identifier.

By virtue of this aspect, the same physical access point is used for another LVAP access point with a different BSSID, and the total number of beacon signals transmitted remains similar to that corresponding to the conventional case of a physical access point, where the beacon signals continue to be transmitted, with the same BSSID, after association with a station.

According to one aspect of the invention, the first virtual Wi-Fi access point is also assigned to at least one other physical Wi-Fi access point, and the beacon messages comprising the first BSSID identifier are also transmitted repeatedly by the at least one other physical Wi-Fi access point.

This aspect combines the advantage afforded by a single LVAP across a set of physical access points with the advantage of faster association with a station, by virtue of the beacon signals that each physical access point transmits as a single virtual access point.

The advantage afforded by a single LVAP assigned to multiple physical access points, in other words distributed across each thereof, is that of making it possible to improve Wi-Fi coverage with a single BSSID, and thus associate the LVAP access point with a station even more quickly.

According to one aspect of the invention, the beacon messages comprising the first BSSID identifier are transmitted repeatedly in turn by the physical Wi-Fi access point and the at least one other physical Wi-Fi access point.

By virtue of this aspect, the number of beacon signals of the LVAP access point remains similar to that corresponding to the conventional case of a single physical access point, since it is not multiplied by the number of physical access points on which the LVAP access point is generated. In addition, by virtue of this synchronization between the physical access points in the transmission of the beacon signals, it is possible to avoid problems in a station receiving two identical beacon signals from two different sources within an excessively short interval.

According to one aspect of the invention, the interval between two beacon messages comprising the first BSSID identifier is substantially equal to 100 ms.

By virtue of this aspect, everything runs for a station exactly as though there were a single physical access point, with the same speed of association, whereas Wi-Fi coverage is in fact that provided by multiple physical access points. An interval of 100 ms between beacon messages is optimum, but in practice a variation of 1 to 2 ms in the value of this interval is acceptable.

According to one aspect of the invention, the first virtual Wi-Fi access point assigned to the at least one other physical Wi-Fi access point is deleted, and replaced by the second virtual Wi-Fi access point identified by the second BSSID identifier.

By virtue of this aspect, the set of physical access points transmit beacon signals with a single BSSID at all times. Indeed, as soon as a station is associated with a physical access point on which the first virtual access point exists, identified by the first BSSID, all of the physical access points of the set stop transmitting beacon signals with this first BSSID so as to transmit beacon signals with a second BSSID. Thus, seen from the stations, everything runs as though there were only one physical Wi-Fi access point at all times. As soon as a station associates with the BSSID, the set of physical access points remains available in the same way for other stations that are not yet associated, but with another BSSID.

It will be understood that, by virtue of the invention, in contrast to the prior art, there is only a single LVAP access point available per physical access point at all times. In theory, a very large number of LVAP access points may be mapped to a single physical Wi-Fi access point (up to 64 or 128 at present, but with no theoretical limit). Limiting the number of LVAP access points per physical access point to only one avoids the major drawback constituted by the multitude of beacon signals transmitted by all of the physical access points for all of the virtual access points.

The invention also relates to a method for the optimized management of virtual Wi-Fi access points, comprising the following steps implemented by a controller of a set of physical Wi-Fi access points:
Assigning a first virtual Wi-Fi access point identified by a first BSSID identifier to the physical Wi-Fi access points of the set;
Transmitting a message comprising the first BSSID identifier to the physical access points of the set;
Receiving a message relating to an association of a station with a physical access point of the set, comprising the first BSSID identifier;
Assigning a second virtual Wi-Fi access point identified by a second BSSID identifier to the physical Wi-Fi access points of the set;
Transmitting a message comprising the second BSSID identifier, intended to replace the first BSSID identifier, to the physical access points of the set.

By virtue of this method, the controller is able to ensure that a single LVAP access point BSSID is broadcast at all times by the beacon signals of the physical access points of the set. As soon as the controller is informed that a station has associated using this BSSID, it may also immediately modify this LVAP BSSID on all of the physical access points. Thus, a single BSSID is broadcast by all of the physical access points and is available to all of the stations, before, during and after association with one of the stations.

According to one aspect of the invention, the controller assigns a distinct virtual Wi-Fi access point, with a distinct identifier, to each physical Wi-Fi access point of the set.

By virtue of this aspect, each physical Wi-Fi access point transmits different beacon messages depending on the transmitter, thereby simplifying processing thereof by a station receiving them and eliminating any need for synchronization between the transmitters.

According to one aspect of the invention, the physical access points of the set are selected by the controller based on information in relation to proximity between them.

This aspect avoids physical access points that are using a single LVAP access point BSSID being too far apart from one another, which would reduce the advantages afforded by the methods according to the invention, since a station would risk not receiving all of the beacon signals.

For example, the number of partitions separating the various physical access points of the set may be taken into account to weight the distances between them, in order to limit the maximum distance to around ten meters.

According to one aspect of the invention, the number of physical access points of the set is limited by the controller so as to be less than or equal to a threshold.

This aspect avoids increasing the number of beacon signals if they are not synchronized between the various physical access points, or makes this synchronization simpler and more efficient in the opposite case. Indeed, if each physical access point transmits a beacon signal without synchronization, a station risks receiving an excessive number of beacon messages within the same time interval if there are too many access points.

It is thus possible to determine an optimum number of physical access points of the set so that, at any point within the radio coverage area generated by the set of physical access points, a station is able to receive a beacon signal approximately every 100 ms.

The various aspects of the method for the optimized management of virtual Wi-Fi access points, implemented by a physical Wi-Fi access point, or by a Wi-Fi access point controller, which have just been described may be implemented independently of one another or in combination with one another.

The invention also relates to a device contained in a physical Wi-Fi access point to which a first virtual Wi-Fi access point identified by a first BSSID identifier is assigned, the device comprising a receiver, a transmitter, a processor and a memory coupled to the processor and containing instructions intended to be executed by the processor in order to:
Receive a message comprising the first BSSID identifier;
Repeatedly transmit beacon messages comprising the first BSSID identifier;
Associate with a Wi-Fi station on the basis of the first BSSID identifier;
Stop the repeated transmission of the beacon messages comprising the first BSSID identifier.

This device, which is able, in all of its embodiments, to implement the method for the optimized management of virtual Wi-Fi access points that has just been described, is intended to be implemented in a physical Wi-Fi access point.

The invention also relates to a device contained in a controller of a set of physical Wi-Fi access points, the device comprising a receiver, a transmitter, a processor and a memory coupled to the processor and containing instructions intended to be executed by the processor in order to:
Assign a first virtual Wi-Fi access point identified by a first BSSID identifier to the physical Wi-Fi access points of the set;
Transmit a message comprising the first BSSID identifier to the physical access points of the set;
Receive a message relating to an association of a station with a physical access point of the set, comprising the first BSSID identifier;
Assign a second virtual Wi-Fi access point identified by a second BSSID identifier to the physical Wi-Fi access points of the set;
Transmit a message comprising the second BSSID identifier, intended to replace the first BSSID identifier, to the physical access points of the set.

This device, which is able, in all of its embodiments, to implement the method for the optimized management of virtual Wi-Fi access points that has just been described, is intended to be implemented in a control equipment for controlling a set of Wi-Fi access points, for example an SDN (Software-Defined Networking) controller.

The invention also relates to computer programs comprising instructions that, when these instructions are executed by a processor, cause said processor to implement the steps of the method for the optimized management of virtual Wi-Fi access points that has just been described.

The invention also targets information media able to be read by a physical Wi-Fi access point and by a controller of a set of Wi-Fi access points and comprising computer program instructions as mentioned above.

The abovementioned programs may use any programming language, and be in the form of source code, object code, or of intermediate code between source code and object code, such as in a partially compiled form, or in any other desirable form.

The abovementioned information media may be any entity or device capable of storing the program. For example, a medium may include a storage means, such as a ROM, for example a CD-ROM or a microelectronic circuit ROM, or else a magnetic recording means.

Such a storage means may be for example a hard disk, a flash memory, etc. Moreover, an information medium may be a transmissible medium such as an electrical or optical signal, which may be routed via an electrical or optical cable, by radio or by other means. A program according to the invention may in particular be downloaded from a network such as the Internet.

Alternatively, an information medium may be an integrated circuit in which a program is incorporated, the circuit being designed to execute or to be used in the execution of the methods in question.

### 4. PRESENTATION OF THE FIGURES

Other advantages and features of the invention will become more clearly apparent from reading the following description of one particular embodiment of the invention, given by way of simple illustrative and non-limiting example, and the appended drawings, in which:

FIG. 1a illustrates a first part of the principle of the optimized management of virtual Wi-Fi access points, according to the first embodiment of the invention,

FIG. 1b illustrates a second part of the principle of the optimized management of virtual Wi-Fi access points, according to the first embodiment of the invention,

FIG. 1c illustrates a third part of the principle of the optimized management of virtual Wi-Fi access points, according to the first embodiment of the invention,

FIG. 1d illustrates a fourth part of the principle of the optimized management of virtual Wi-Fi access points, according to the first embodiment of the invention,

FIG. 1e illustrates a fifth part of the principle of the optimized management of virtual Wi-Fi access points, according to the first embodiment of the invention,

FIG. 2 shows one exemplary implementation of the optimized management of virtual Wi-Fi access points, according to the first embodiment of the invention,

FIG. 3a illustrates a first part of the principle of the optimized management of virtual Wi-Fi access points, according to a second embodiment of the invention,

FIG. 3b illustrates a second part of the principle of the optimized management of virtual Wi-Fi access points, according to the second embodiment of the invention,

FIG. 3c illustrates a third part of the principle of the optimized management of virtual Wi-Fi access points, according to the second embodiment of the invention,

FIG. 3d illustrates a fourth part of the principle of the optimized management of virtual Wi-Fi access points, according to the second embodiment of the invention,

FIG. 3e illustrates a fifth part of the principle of the optimized management of virtual Wi-Fi access points, according to the second embodiment of the invention,

FIG. 4 shows one exemplary implementation of the optimized management of virtual Wi-Fi access points, according to the second embodiment of the invention,

FIG. 5 shows one example of a structure of a device in a physical Wi-Fi access point, implementing the method for the optimized management of virtual Wi-Fi access points, according to one aspect of the invention,

FIG. 6 shows one example of a structure of a device in a Wi-Fi access point controller, implementing the method for the optimized management of virtual Wi-Fi access points, according to one aspect of the invention.

### 5. DETAILED DESCRIPTION OF AT LEAST ONE EMBODIMENT OF THE INVENTION

In the remainder of the description, exemplary embodiments of the invention based on a set of 3 physical access points of a Wi-Fi network are presented, but it goes without saying that the invention is applicable to all variations of the IEEE 802.11 standards, and to any number of physical access points. The term BSSID, inter alia, identifying an LVAP access point, is just one exemplary way of identifying a Wi-Fi access point, whether physical or virtual.

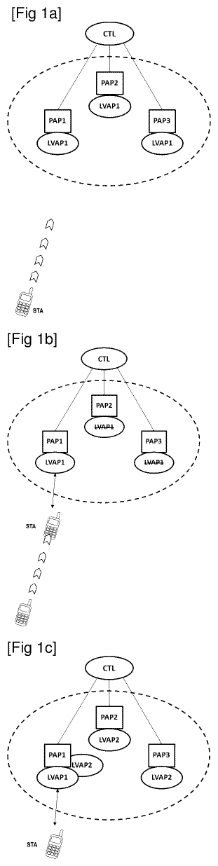

FIGS. 1a to 1e illustrate the principle of the optimized management of virtual Wi-Fi access points, according to the first embodiment of the invention.

The principle is illustrated with the aid of an example comprising 3 physical Wi-Fi access points denoted PAP1, PAP2, and PAP3, managed by a controller CTL. This controller assigns the same virtual Wi-Fi access point, denoted LVAP1 and identified by a BSSID equal to BSSID1, to all of the physical access points. As long as no station is associated with LVAP1 (FIG. 1a), all of the physical access points transmit beacon signals comprising BSSID1.

When a station STA approaches the set of physical access points, it associates with the virtual access point LVAP1 (FIG. 1b), for example via the nearest physical access point PAP1. The virtual access point LVAP1 is then deleted by the controller from the other physical access points PAP2 and PAP3. All of the physical access points stop transmitting beacon signals comprising BSSID1.

The controller then assigns another virtual Wi-Fi access point, denoted LVAP2 and identified by a BSSID equal to BSSID2, to all of the physical access points (FIG. 1c). As long as no station is associated with LVAP2, all of the physical access points transmit beacon signals comprising BSSID2.

If the station moves away from PAP1 and closer to PAP3, the controller CTL moves the virtual access point LVAP1 from PAP1 to PAP3, in a manner transparent for the station STA (FIG. 1d). During this time, all of the physical access points continue to transmit beacon signals comprising BSSID2.

If another station distinct from STA associates with the virtual access point LVAP2, the controller CTL, as above for LVAP1, will delete LVAP2 except for from the physical access point carrying the association, and will generate a new LVAP in order to assign it to all of the physical access points. This new virtual access point (not illustrated), for example LVAP3 identified by a BSSID equal to BSSID3, is distinct from those already assigned by the controller CTL, that is to say distinct from LVAP1 and LVAP2. The physical access points then stop transmitting beacon signals comprising BSSID2 and start transmitting beacon signals comprising BSSID3.

If the association between the station STA and the virtual access point LVAP1 disappears (FIG. 1e), for example because the station STA moves too far away from the set of physical access points and is no longer within radio coverage thereof, or simply because the station STA is turned off, the virtual access point LVAP1 is deleted from the physical access point PAP3 by the controller CTL. Since the virtual access point LVAP2 has already been assigned beforehand to the physical access point PAP3 and already transmits beacon signals comprising BSSID2, its availability for other stations is not affected.

It will be understood that, by virtue of the beacon signals transmitted by the physical access points carrying the same virtual access point, not only is the radio range of the virtual access point improved, but also the speed of association of a station with this virtual access point is increased. In addition, by virtue of renewing the virtual access point as soon as a station associates therewith, its availability and its association speed are guaranteed at all times.

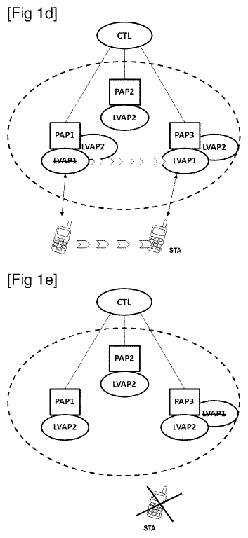

FIG. 2 shows one exemplary implementation of the optimized management of virtual Wi-Fi access points, according to a first embodiment of the invention.

In this first embodiment, it will be recalled that the same LVAP BSSID identifier is assigned to multiple physical Wi-Fi access points.

In a step E1001, the controller CTL generates an identifier BSSID1 for a first virtual access point LVAP1, and assigns BSSID1, as an LVAP identifier, to each of the physical Wi-Fi access points of a set that it manages. In one example, the set comprises 3 physical Wi-Fi access points, denoted PAP1, PAP2, PAP3, respectively.

In steps E1011, E1012 and E1013, the controller CTL transmits assignment messages comprising the identifier BSSID1, which are received by PAP1, PAP2 and PAP3, respectively.

Following the receipt of such an assignment message, a physical access point starts transmitting beacon messages comprising the identifier BSSID1.

Thus, in steps E1021, E1022 and E1023, the physical access points PAP1, PAP2 and PAP3, respectively, each repeatedly transmit a beacon message Bcn comprising the identifier BSSID1.

In a first exemplary implementation of this first embodiment, these beacon messages are transmitted independently by each physical access point of the set, without synchronization between them. Typically, a Wi-Fi access point transmits a beacon message every 100 ms. As a result, a station within radio proximity of the 3 access points receives three beacon messages within the same interval of 100 ms, comprising the same BSSID. This has the advantage of simplicity, but may lead to complications in the station if beacon messages with the same BSSID are too close in time.

In a second exemplary implementation of this first embodiment, these beacon messages are transmitted in turn by each physical access point of the set. This requires synchronization between them, but has the advantage of simplifying the processing of the beacon messages by a station receiving them. For example, to transmit its beacon message, a physical access point waits 100 ms after transmission by the physical access point that is before it in the transmission order. A station within radio proximity of the 3 access points thereby receives a beacon message comprising the same BSSID every 100 ms, this being the normal situation with a conventional non-LVAP access point. The process is therefore completely transparent for the station, which believes that it is in the presence of a single Wi-Fi access point transmitting its beacon message every 100 ms.

In order to ensure this synchronization between the physical Wi-Fi access points of the set, the assignment messages transmitted by the controller CTL in steps E1011, E1012 and E1013 may for example comprise a rank number, or a time offset value with respect to a reference time, which is specific to the access point receiving the assignment message.

Whether the transmission is synchronized or not, the beacon messages are received by a station within radio proximity of the three physical access points, with a different signal strength depending on the physical access point.

In a step E1031, in response to the receipt of the beacon messages, the station STA transmits a Probe Request PRq comprising at least one MAC address of the terminal STA. This request PRq comprises a MAC address of the station STA and may be transmitted in broadcast mode or in unicast mode. In the latter case, the request comprises an access point identifier, for example equal to BSSID1.

The physical access points PAP1, PAP2 and PAP3 are within a radio area enabling them to receive this request PRq.

In steps E1041, E1042 and E1043, the physical access points PAP1, PAP2 and PAP3, respectively, that received the request PRq each transmit, to the controller CTL, a message comprising the MAC address of the station STA along with a datum referred to as RSSI (Received Signal Strength Indicator) indicating the strength of the signal carrying the request message PRq and received by the respective physical access point. The message transmitted by the physical access points to the controller may comprise a copy of the request PRq.

In a step E1051, the controller CTL, on the basis of the messages received in steps E1041, E1042 and E1043, selects the most appropriate physical access point out of PAP1, PAP2 and PAP3 to be associated with the station MAC. For example, the physical access point PAP1 is selected since its RSSI datum is the highest. The selected physical access point may also be the first one in time that sends the controller a message relating to the request PRq from the station STA, this having the advantage of speed if one of the physical access points of the set is out of range at the time when the others receive the request PRq from the station STA. The controller therefore does not wait to receive the message from all of the access points of the set to select the one to which the station may attach, even if it changes the station over later to another, more appropriate access point.

The controller CTL then transmits, to the physical access point PAP1, a message comprising an instruction to respond to the station STA with a Probe Response message, and to stop transmitting beacon messages with the identifier BSSID1.

In this step E1051, the controller CTL also generates an identifier BSSID2, distinct from BSSID1, for a second virtual access point LVAP2, and assigns BSSID2, as an LVAP identifier, to each of the physical Wi-Fi access points of the set that it manages, that is to say PAP1, PAP2 and PAP3.

In a step E1061, the physical access point PAP1 that received the instruction message transmitted by CTL in step E1051, PAP1, transmits a Probe Response PRs to the station STA, comprising the MAC address of STA and the identifier BSSID1, along with any other information enabling the association between station and access point (for example relating to the capabilities of the access point).

In a step E1071, the station STA that received the response PRs performs a known authentication process that leads, as seen from the station STA, to it being associated with the virtual Wi-Fi access point LVAP1 identified by BSSID1, even though, at this time, LVAP1 is carried by the physical Wi-Fi access point PAP1.

In steps E1081, E1082 and E1083, the controller CTL transmits assignment messages comprising the identifier BSSID2, which are received by PAP1, PAP2 and PAP3, respectively.

Following the receipt of such an assignment message, these physical access points firstly stop transmitting the beacon messages comprising the identifier BSSID1, and secondly start transmitting beacon messages Bcn2 comprising the identifier BSSID2 (messages not illustrated in FIG. 2 since they are not “heard” by STA) and able to be received by any station within radio coverage of PAP1, PAP2 and PAP3.

The order of steps E1051, E1081, E1082 and E1083 does not matter.

Step E1081 may be included in step E1051; in this case, only one message is transmitted to PAP1 in order, in one go, to:
1) command the association of STA with LVAP1 carried by PAP1,
2) stop the transmission of beacon messages for LVAP1,
3) assign the new LVAP2 to PAP1, and
4) start the transmission of beacon messages Bcn2.

In some variants where the stopping of the beacon messages for LVAP1 is decorrelated from the activation of the beacon messages for LVAP2, the assignment messages in steps E1081, E1082 and E1083 may be multiplied and carry only one instruction at a time out of the instructions numbered 2, 3 or 4 above.

Once the station STA has been associated with the virtual access point LVAP1, the latter may be moved, in a manner completely transparent for the station STA (that is to say, inter alia, without the need for a new authentication phase as in step E1071), to another physical access point, depending on the fluctuation in the radio quality of the association. This is a known process that is summarized briefly below in relation to steps E1091 to E1112.

The signal transmitted by the station STA is perceived by all of the physical access points within radio proximity, namely PAP1, PAP2, and PAP3, which are configured to measure this signal. In steps E1091, E1092 and E1093, the physical access points PAP1, PAP2 and PAP3, respectively, each repeatedly transmit, to the controller CTL, a message comprising a datum, referred to as KPI, indicating this measurement. This KPI datum may for example be an RSSI datum, or an SNR (Signal-to-Noise Ratio) datum.

At any time after step E1071 (when the station STA is associated with the physical access point PAP1 carrying LVAP1 identified by BSSID1), on the basis of the measurement reports that it has received, the controller CTL determines, in a step E1101, that the connection between the physical access point PAP1 and the station STA is no longer optimum, according to a determined changeover criterion. This changeover criterion is for example related to the received measurements and to a predetermined quality threshold that a received measurement must or must not exceed.

In this step E1011, the controller CTL, which has also received measurement reports from the other physical access points PAP2 and PAP3, detects that the physical access point PAP3 satisfies the changeover criterion.

These changes in the values of the measurements used by the controller CTL to decide on a changeover may for example simply be the result of a movement of the station STA, which has moved away from PAP1 and closer to PAP3, or the result of a more complex change of situation, such as the occurrence of radio interference in the radio channel between STA and PAP1, or the need to prioritize flows from another station also connected to PAP1.

In steps E1111 and E1112, on the basis of the changeover criterion, the controller CTL moves the identifier BSSID1 of LVAP1, along with its characteristics, its routing rules, and therefore the attachment of the station STA, from the physical access point PAP1 to the physical access point PAP3. For this purpose, the controller CTL, in step E1111, transmits a request to delete BSSID1 to the physical access point PAP1 and, in step E1112, transmits a request to add BSSID1 to the physical access point PAP3. Corresponding acknowledgement messages, not illustrated, are also transmitted. The result of these changeover steps is that the station STA is still associated with the virtual access point LVAP1 identified by BSSID1, but the association is now carried by the physical access point PAP3, and no longer the physical access point PAP1, in a manner completely transparent for the station STA.

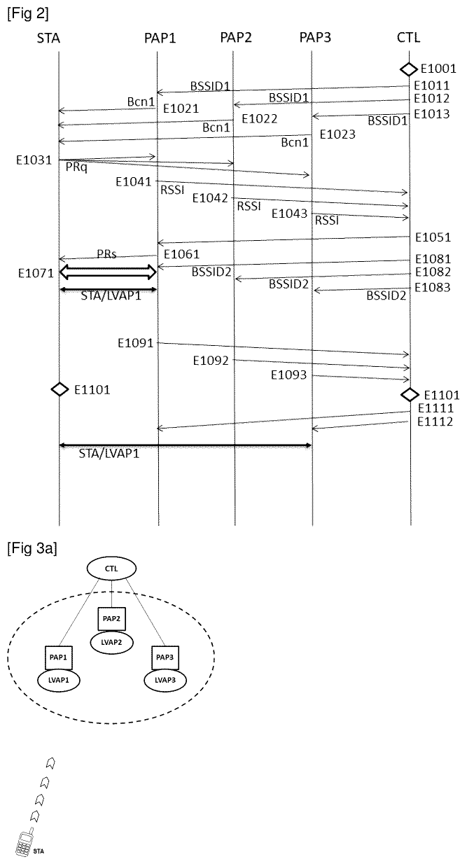

FIGS. 3a to 3e illustrate the principle of the optimized management of virtual Wi-Fi access points, according to the second embodiment of the invention.

Unlike the first embodiment, the controller CTL assigns a distinct virtual Wi-Fi access point to each physical access point. For example, it assigns the virtual access point LVAP1 identified by a BSSID equal to BSSID1 to the physical access point PAP1, the virtual access point LVAP2 identified by a BSSID equal to BSSID2 to the physical access point PAP2, and the virtual access point LVAP3 identified by a BSSID equal to BSSID3 to the physical access point PAP3.

As long as no station is associated with a given virtual access point (FIG. 3a), the corresponding physical access point transmits beacon signals comprising the corresponding BSSID, that is to say BSSID1 for PAP1, BSSID2 for PAP2, and BSSID3 for PAP3.

When a station STA approaches the set of physical access points, it associates for example with the virtual access point LVAP1, via the nearest physical access point PAP1 (FIG. 3b). The virtual access point LVAP1 then stops transmitting beacon signals comprising BSSID1.

The controller CTL then assigns another virtual Wi-Fi access point distinct from those already assigned by the controller CTL, denoted LVAP4 and identified by a BSSID equal to BSSID4, only to the physical access point PAP1 (FIG. 3c). The physical access point PAP1 then starts transmitting beacon signals comprising BSSID4.

If the station moves away from PAP1 and closer to PAP3, the controller CTL moves the virtual access point LVAP1 from PAP1 to PAP3, in a manner transparent for the station STA (FIG. 3d). During this time, all of the physical access points continue to transmit beacon signals comprising their respective BSSID.

If another station distinct from STA associates with one of the virtual access points, for example LVAP2 carried by the physical access point PAP2, the controller CTL, as above, will assign a new virtual access point, for example denoted LVAP5 and identified by a BSSID equal to BSSID5 (not illustrated) that is distinct from those already assigned by the controller CTL, that is to say distinct from LAVAP1, LVAP2, LVAP3 and LVAP4, only to the physical access point PAP2. The physical access point PAP2 then stops transmitting beacon signals comprising BSSID2 and starts transmitting beacon signals comprising BSSID5.

If the association between the station STA and the virtual access point LVAP1 disappears (FIG. 3e), for example because the station STA moves too far away from the set of physical access points and is no longer within radio coverage thereof, or because the station STA is turned off, the virtual access point LVAP1 is deleted from the physical access point PAP3 by the controller CTL. Since the virtual access point LVAP3 has already been assigned beforehand to the physical access point PAP3 and already transmits beacon signals comprising BSSID3, its availability for other stations is not affected.

It will be understood that, by virtue of the beacon signals transmitted by the physical access points each carrying a distinct virtual access point, not only is the radio range of the virtual access points as a whole improved, but also the speed of association of a station with one of these virtual access points is increased. In addition, by virtue of renewing the virtual access point as soon as a station associates therewith, its availability and its association speed are guaranteed at all times.

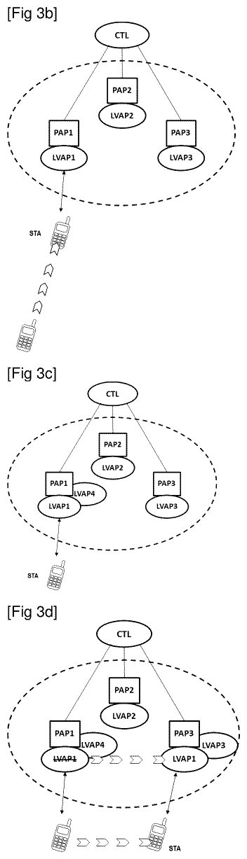

FIG. 4 shows one exemplary implementation of the optimized management of virtual Wi-Fi access points, according to a second embodiment of the invention.

In this second embodiment, it will be recalled that a distinct LVAP BSSID identifier is assigned to each physical Wi-Fi access point.

In a step E2001, the controller CTL generates distinct BSSID identifiers BSSID1, BDDIS2 and BSSID3 for each of the 3 virtual access points LVAP1, LVAP2 and LVAP3, respectively, and assigns the BSSID identifiers to each of the physical Wi-Fi access points of a set that it manages. The controller CTL assigns BSSID1, BSSID2 and BSSID3, as an LVAP identifier, to the physical access points PAP1, PAP2, and PAP3, respectively.

In a step E2011, the controller CTL transmits an assignment message comprising the identifier BSSID1, which are received by PAP1.

In a step E2012, the controller CTL transmits an assignment message comprising the identifier BSSID2, which are received by PAP2.

In a step E2013, the controller CTL transmits an assignment message comprising the identifier BSSID3, which are received by PAP3.

Following the receipt of such assignment messages, the physical access points start transmitting beacon messages comprising the BSSID identifier that has been assigned to them.

Thus, in steps E2021, E2022 and E2023, respectively, the physical access points PAP1, PAP2 and PAP3 each repeatedly transmit a beacon message Bcn1 comprising the identifier BSSID1, a beacon message Bcn2 comprising the identifier BSSID2, and a beacon message Bcn2 comprising the identifier BSSID3.

In one exemplary implementation of this second embodiment, these beacon messages are transmitted independently by each physical access point of the set, without synchronization between them. Typically, a Wi-Fi access point transmits a beacon message every 100 ms. As a result, a station within radio proximity of the 3 access points receives on average three beacon messages Bcn1, Bcn2 and Bcn3 within the same interval of 100 ms, comprising BSSID1, BSSID2 and BSSID3, respectively.

The beacon messages are received by a station within radio proximity of the three physical access points, with a different signal strength depending on the physical access point.

In a step E2031, in response to the receipt of the beacon messages, the station STA transmits [in unicast mode or in multicast mode?] a Probe Request PRq comprising at least one MAC address of the terminal STA. This request PRq comprises a MAC address of the station STA and may be transmitted in broadcast mode or in unicast mode. In the former case, all of the physical access points process the request PRq. In the latter case, the request PRq comprises an access point identifier, for example equal to BSSID1, and only the access point PAP1 processes it.

The physical access points PAP1, PAP2 and PAP3 are within a radio area enabling them to receive this request PRq.

In steps E2041, E2042 and E2043, the physical access points PAP1, PAP2 and PAP3, respectively, each transmit, to the controller CTL, a message comprising the MAC address of the station STA along with a datum referred to as RSSI (Received Signal Strength Indicator) indicating the strength of the signal carrying the request message PRq and received by the respective physical access point. The message transmitted by the physical access points to the controller may comprise a copy of the request PRq.

In a step E2051, the controller CTL, on the basis of the messages received in steps E2041, E2042 and E2043, selects the most appropriate physical access point out of PAP1, PAP2 and PAP3 to be associated with the station MAC. For example, the physical access point PAP1 is selected since its RSSI datum is the highest.

The selected physical access point may also be the first one in time that sends the controller a message relating to the request PRq from the station STA, this having the advantage of speed if one of the physical access points of the set is out of range at the time when the others receive the request PRq from the station STA. The controller therefore does not wait to receive the message from all of the access points of the set to select the one to which the station may attach, even if it changes the station over later to another, more appropriate access point.

Similarly, if the station STA transmitted its request PRq in unicast mode, the controller receives a message only from the access point identified in the unicast request PRq, and selects this access point, even if it changes the station over later to another, more appropriate access point.

The controller CTL then transmits, to the physical access point PAP1, a message comprising an instruction to respond to the station STA with a Probe Response message, and to stop transmitting beacon messages with the identifier BSSID1.

In this step E2051, the controller CTL also generates an identifier BSSID4, distinct from the BSSIDs already assigned by the controller CTL, for a new virtual access point LVAP4, and assigns BSSID4, as an LVAP identifier, to the physical Wi-Fi access point PAP1.

In a step E2061, the physical access point PAP1 that received the instruction message transmitted by CTL in step E2051, PAP1, transmits a Probe Response PRs to the station STA, comprising the MAC address of STA and the identifier BSSID1, along with any other information enabling the association between station and access point (for example relating to the capabilities of the access point).

In a step E2071, the station STA that received the response PRs performs a known authentication process that leads, as seen from the station STA, to it being associated with the virtual Wi-Fi access point LVAP1 identified by BSSID1, even though, at this time, LVAP1 is carried by the physical Wi-Fi access point PAP1.

In a step E2081, the controller CTL transmits an assignment message comprising the identifier BSSID4, which are received by PAP1.

Following the receipt of such an assignment message, the physical access point PAP1 firstly stops transmitting the beacon messages Bcn1 comprising the identifier BSSID1, and secondly starts transmitting beacon messages Bcn4 comprising the identifier BSSID4 (messages not illustrated in FIG. 2 since they are not “heard” by STA) and able to be received by any station within radio coverage of PAP1.

Step E2081 may be included in step E2051; in this case, only one message is transmitted to PAP1 in order, in one go, to:
1) command the association of STA with LVAP1 carried by PAP1,
2) stop the transmission of beacon messages for LVAP1,
3) assign the new LVAP4 to PAP1, and
4) start the transmission of beacon messages Bcn4.

In some variants where the stopping of the beacon messages for LVAP1 is decorrelated from the activation of the beacon messages for LVAP4, the assignment message in step E2081 may be multiplied and carry only one instruction at a time out of the instructions numbered 2, 3 or 4 above.

Once the station STA has been associated with the virtual access point LVAP1, the latter may be moved, in a manner completely transparent for the station STA (that is to say, inter alia, without the need for a new authentication phase as in step E2071), to another physical access point, depending on the fluctuation in the radio quality of the association. This is a known process, illustrated by steps E2091 to E2112, which are identical, respectively, to steps E1091 to E1112 already described in relation to FIG. 2.

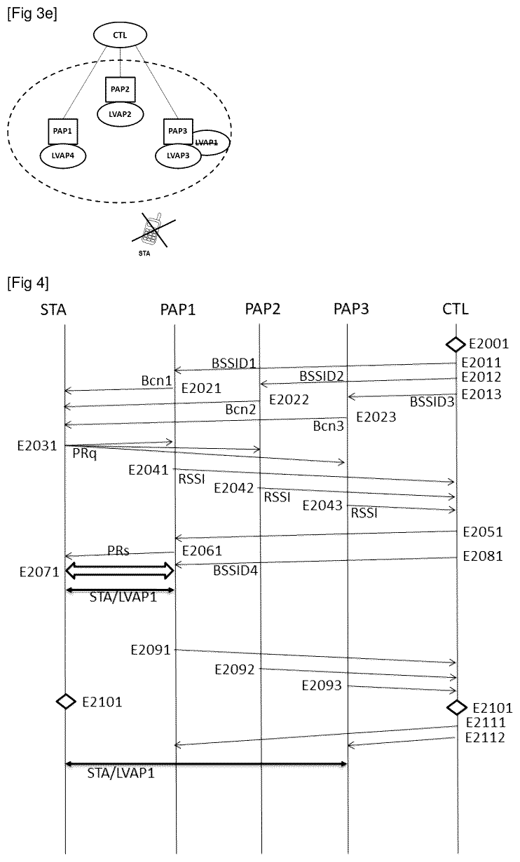

FIG. 5 shows one example of a structure of a device in a physical Wi-Fi access point, implementing the method for the optimized management of virtual Wi-Fi access points, according to one aspect of the invention.

The device 100 implements the method for the optimized management of virtual Wi-Fi access points, various embodiments of which have just been described.

Such a device 100 may be implemented in a physical Wi-Fi access point, such as for example the access point PAP1.

For example, the device 100 comprises a receiver 101, a transmitter 102, a processing unit 130, equipped for example with a microprocessor μP, and controlled by a computer program 110, stored in a memory 120 and implementing the optimized management method according to the invention. On initialization, the code instructions of the computer program 110 are for example loaded into a RAM memory, before being executed by the processor of the processing unit 130.

Such a memory 120, such a processor of the processing unit 130, such a receiver 101 and such a transmitter 102 are able and configured to:
Receive a message comprising a first BSSID identifier (BSSID1);
Repeatedly transmit beacon messages (Bcn1) comprising the first BSSID identifier;
Associate with a Wi-Fi station (STA) on the basis of the first BSSID identifier;
Stop the repeated transmission of the beacon messages comprising the first BSSID identifier.

Advantageously, they are also able and configured to:
Transmit a message relating to the association, comprising the first BSSID identifier;
Receive a message comprising a second BSSID identifier (BSSID2; BSSID4) of a second virtual Wi-Fi access point assigned to the physical Wi-Fi access point;
Repeatedly transmit beacon messages (Bcn2) comprising the second BSSID identifier.

Optionally, they are also able and configured to synchronize the repeated transmission of the beacon messages comprising the first BSSID identifier by transmitting repeatedly in turn with other physical Wi-Fi access points.

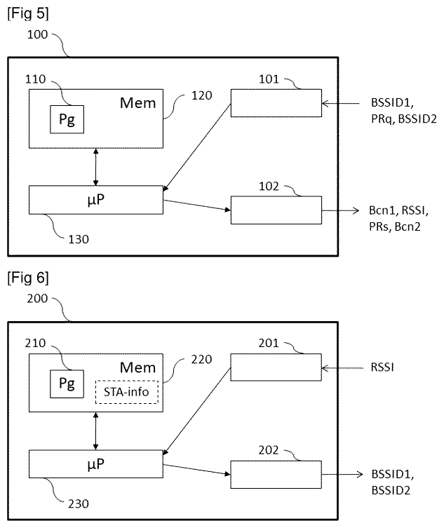

FIG. 6 shows one example of a structure of a device in a Wi-Fi access point controller, implementing the method for the optimized management of virtual Wi-Fi access points, according to one aspect of the invention.

The device 200 implements the method for the optimized management of virtual Wi-Fi access points, various embodiments of which have just been described.

Such a device 200 may be implemented in a control equipment for controlling a set of Wi-Fi access points, such as an SDN controller, such as for example the controller CTL.

For example, the device 200 comprises a receiver 201, a transmitter 202, a processing unit 230, equipped for example with a microprocessor μP, and controlled by a computer program 210, stored in a memory 220 and implementing the optimized management method according to the invention. On initialization, the code instructions of the computer program 210 are for example loaded into a RAM memory, before being executed by the processor of the processing unit 230.

Such a memory 220, such a processor of the processing unit 230, such a receiver 201 and such a transmitter 202 are able and configured to:
Assign a first virtual Wi-Fi access point (LVAP1) identified by a first BSSID identifier (BSSID1) to the physical Wi-Fi access points of the set;
Transmit a message comprising the first BSSID identifier to the physical access points of the set;
Receive a message relating to an association of a station (STA) with a physical access point (PAP1) of the set, comprising the first BSSID identifier;
Assign a second virtual Wi-Fi access point (LVAP2; LVAP4) identified by a second BSSID identifier (BSSID2; BSSID4) to the physical Wi-Fi access points of the set;
Transmit a message comprising the second BSSID identifier, intended to replace the first BSSID identifier, to the physical access points of the set.

Advantageously, they are also able and configured to select the physical access points of the set based on information in relation to proximity between them.

The entities described and contained in the devices described in relation to FIGS. 5 and 6 may be hardware-based or software-based. FIGS. 5 and 6 illustrate just one particular way out of multiple possible ways of implementing the method described above in relation to the preceding figures. Indeed, the technique of the invention may be carried out equally well on a reprogrammable computing machine (a PC, a DSP or a microcontroller) executing a program comprising a sequence of instructions or on a dedicated computing machine (for example a set of logic gates such as an FPGA or an ASIC, or any other hardware module).

If the invention is installed on a reprogrammable computing machine, the corresponding program (that is to say the sequence of instructions) may be stored on a removable storage medium (such as for example a USB stick, a floppy disk, a CD-ROM or a DVD-ROM) or a non-removable storage medium, this storage medium being able to be read partially or completely by a computer or a processor.

1. A method implemented by a physical Wi-Fi access point to which a first virtual Wi-Fi access point identified by a first BSSID identifier is assigned, wherein the method comprises:
receiving a message comprising the first BSSID identifier;
repeatedly transmitting beacon messages comprising the first BSSID identifier;
associating a Wi-Fi station with the physical Wi-Fi access point on the basis of the first BSSID identifier; and
stopping the repeated transmission of the beacon messages comprising the first BSSID identifier.

2. The method as claimed in claim 1, wherein the associating is followed by:
transmitting a message relating to the association, comprising the first BSSID identifier;
receiving a message comprising a second BSSID identifier of a second virtual Wi-Fi access point assigned to the physical Wi-Fi access point; and
repeatedly transmitting beacon messages comprising the second BSSID identifier.

3. The method as claimed in claim 2, wherein the first virtual Wi-Fi access point is also assigned to at least one other physical Wi-Fi access point, and wherein the beacon messages comprising the first BSSID identifier are also transmitted repeatedly by the at least one other physical Wi-Fi access point.

4. The method as claimed in claim 3, wherein the beacon messages comprising the first BSSID identifier are transmitted repeatedly in turn by the physical Wi-Fi access point and the at least one other physical Wi-Fi access point-.

5. The method as claimed in claim 1, wherein an interval between two beacon messages comprising the first BSSID identifier is substantially equal to 100 ms.

6. The method as claimed in claim 3, wherein the first virtual Wi-Fi access point assigned to the at least one other physical Wi-Fi access point is deleted, and replaced by the second virtual Wi-Fi access point identified by the second BSSID identifier.

7. A method implemented by a controller of a set of physical Wi-Fi access points, wherein the method comprises:
assigning a first virtual Wi-Fi access point identified by a first BSSID identifier to the physical Wi-Fi access points of the set;
transmitting a message comprising the first BSSID identifier to the physical access points of the set;
receiving a message relating to an association of a station with a physical access point of the set, comprising the first BSSID identifier;
assigning a second virtual Wi-Fi access point identified by a second BSSID identifier to the physical Wi-Fi access points of the set; and
transmitting a message comprising the second BSSID identifier, intended to replace the first BSSID identifier, to the physical access points of the set.

8. The method as claimed in claim 7, wherein the physical access points of the set are selected based on information in relation to proximity between them.

9. The method as claimed in claim 7, wherein a number of physical access points of the set is less than or equal to a threshold.

10. A device contained in a physical Wi-Fi access point to which a first virtual Wi-Fi access point identified by a first BSSID identifier is assigned, the device comprising:
a receiver;
a transmitter;
a processor; and
a memory coupled to the processor and containing instructions executable by the processor in order to:
receive a message comprising the first BSSID identifier;
repeatedly transmit beacon messages comprising the first BSSID identifier;
associate with a Wi-Fi station on the basis of the first BSSID identifier; and
stop the repeated transmission of the beacon messages comprising the first BSSID identifier.

11. A device contained in a controller of a set of physical Wi-Fi access points, the device comprising:
a receiver;
a transmitter;
a processor; and
a memory coupled to the processor and containing instructions executable by the processor in order to:
assign a first virtual Wi-Fi access point identified by a first BSSID identifier to the physical Wi-Fi access points of the set;
transmit a message comprising the first BSSID identifier to the physical access points of the set;
receive a message relating to an association of a station with a physical access point of the set, comprising the first BSSID identifier;
assign a second virtual Wi-Fi access point identified by a second BSSID identifier to the physical Wi-Fi access points of the set; and
transmit a message comprising the second BSSID identifier, intended to replace the first BSSID identifier, to the physical access points of the set.

12. (canceled)

13. (canceled)

14. (canceled)

15. (canceled)
